(19) United States
(12) Patent Application Publication
(10) Pub. No.: US 2011/0314512 A1
(43) Pub. Date: Dec. 22, 2011

(54) METHODS FOR SECURITY AND MONITORING WITHIN A WORLDWIDE INTEROPERABILITY FOR MICROWAVE ACCESS (WIMAX) NETWORK

(75) Inventors: Amit Sinha, Marlborough, MA (US); Todd W. Nightingale, Atlanta, GA (US); William D. Thomas, Roswell, GA (US)

(73) Assignee: SYMBOL TECHNOLOGIES, INC., Schaumburg, IL (US)

(21) Appl. No.: 12/820,327

(22) Filed: Jun. 22, 2010

(51) Int. Cl. H04L 29/06; G06F 11/00; H04W 80/00

(52) U.S. Cl. 726/1; 726/22; 370/328

(57) ABSTRACT

A method for security and monitoring within a worldwide interoperability for microwave access (WiMAX) network includes monitoring, by one or more sensors, communications activity on one or more channels; analyzing, by either one or more sensors directly or a server provided with reports of the monitored communication activity for detection of one or more system incidents; and triggering, in response to detection of one or more incidents, an incident notification.

### FIELD OF THE DISCLOSURE

The present disclosure relates generally to wireless communication networks and more particularly to security and monitoring within Worldwide Interoperability for Microwave Access (WiMAX) networks.

### BACKGROUND

A wireless metropolitan area network (WMAN) is a form of wireless networking that has an intended coverage area—a range—of approximately the size of a city. A WMAN spans a larger area than a wireless local area network (WLAN) but smaller than a wireless wide area network (WWAN). A WMAN is typically owned by a single entity such as an Internet service provider (ISP), a government entity, or a large corporation. Access to a WMAN is usually restricted to authorized users or subscriber devices.

Worldwide Interoperability for Microwave Access (WiMAX), one form of WMAN, is based on an IEEE 802.16 standard. WiMAX specifically refers to interoperable implementations of the IEEE 802.16 wireless-networks standard. (For these and any Institute of Electrical and Electronics Engineers (IEEE) standards recited herein, see: http://standards.ieee.org/getieee802/index.html or contact the IEEE at IEEE, 445 Hoes Lane, PO Box 1331, Piscataway, N.J. 08855-1331, USA.) The original purpose of IEEE 802.16 technologies was to provide last-mile broadband wireless access as an alternative to cable, digital subscriber line (DSL), or T1 service. Developments in the IEEE 802.16 standard shifted the technology's focus toward a more cellular-like, mobile architecture to serve a broader market. Today, WiMAX is a versatile technology that continues to adapt to market demands and provide enhanced user mobility.

The IEEE 802.16 standards specify two basic security services: authentication and confidentiality. Authentication involves the process of verifying the identity claimed by a WiMAX device. Authentication mechanisms include user authentication and device authentication. Confidentiality involves preventing the disclosure of information by ensuring that only authorized devices can view the contents of WiMAX data messages. The IEEE 802.16 standards do not provide any capability to encrypt management messages.

The IEEE 802.16 standards do not address other security services such as availability and confidentiality protection for management messages; if such services are needed, they must be provided through additional means. Also, IEEE 802.16 security protects communications over the WMAN link between a subscriber station (SS) or mobile subscriber (MS) and a base station (BS), but not communications on the wired operator network behind the BS. End-to-end security is not possible without applying additional security controls not specified by the IEEE standards.

WiMAX networks suffer from security vulnerabilities such as rogue stations, radio frequency (RF) jamming and denial of service, man-in-the-middle attacks, management frame manipulation, and the like. In addition, WiMAX systems are susceptible to performance degradation and connectivity issues like other wireless networks.

Accordingly, there is a need for a WiMAX security and monitoring system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a worldwide interoperability for microwave access (WiMAX) system.

FIG. 2 illustrates a typical deployment for a security and monitoring system in accordance with some embodiments.

FIG. 3 illustrates an embodiment of a security and monitoring system without a server in accordance with some embodiments.

FIGS. 4 and 5 illustrate embodiments of a sensor in accordance with some embodiments.

FIG. 6 illustrates a flowchart of the operation of a security and monitoring system in accordance with some embodiments.

FIG. 7 illustrates an example technique to determine if an observed BS is a rogue BS in accordance with some embodiments.

FIG. 8 illustrates a triangulation based location determination for a station in accordance with some embodiments.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method for security and monitoring within a worldwide interoperability for microwave access (WiMAX) network includes monitoring, by one or more sensors, communications activity on one or more channels; analyzing, by either one or more sensors directly or a server provided with reports of the monitored communication activity for detection of one or more system incidents; and triggering, in response to detection of one or more incidents, an incident notification.

A distributed WiMAX security and monitoring system is provided herein. This system can be used in WiMAX networks to provide enhanced security through elimination of rogue devices and real-time detection of attacks, protocol abuse, behavioral anomalies and policy violations. The system can further be leveraged to provide network assurance to subscribers by detecting performance issues and resolving connectivity problems.

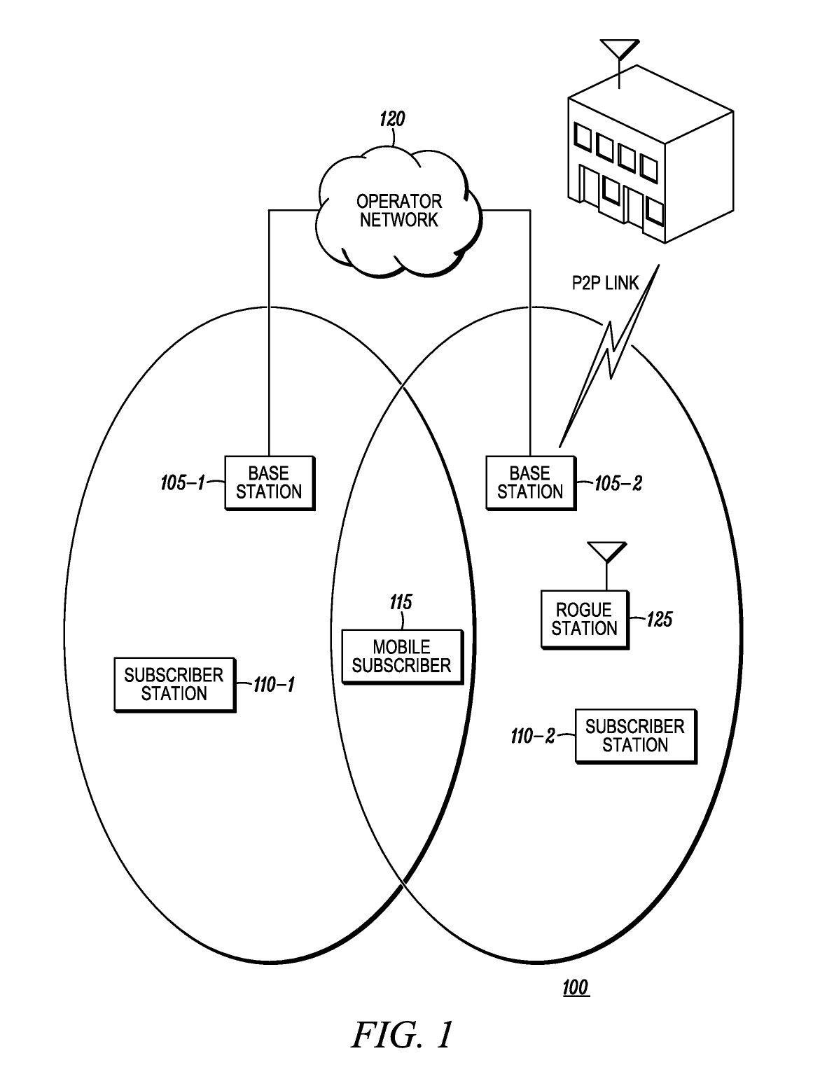

FIG. 1 is a block diagram of a conventional WiMAX system 100. As illustrated, the WiMAX system 100 comprises one or more base stations (BS) 105-n (such as 105-1 and 105-2 as illustrated). Each base station (BS) 105-n is the node that logically connects wireless subscriber devices (such as subscriber stations 110 and mobile subscribers 115) to operator networks 120. The BS maintains communications with subscriber devices and governs access to the operator networks. A BS includes the infrastructure elements necessary to enable wireless communications, (i.e., antennas, radio frequency transceivers, and various integrated circuits) BSs are typically fixed nodes, but they may also be used as part of mobile solutions. For example, a BS may be affixed to a vehicle to provide communications for nearby WiMAX devices. A BS also serves as a Master Relay-Base Station in the multi-hop relay topology.

The WiMAX system 100 further comprises subscriber stations (SS) 110-n such as subscriber station 110-1 and 110-2 as illustrated. The SS 110 is a fixed wireless node. A SS 110 typically communicates only with BSs 105, except for multi-hop relay network operations. SSs 110 are available in both outdoor and indoor models.

The WiMAX system 100 further comprises mobile subscribers (MS) 115. Defined in IEEE 802.16e-2005, MSs 115 are wireless nodes that work at vehicular speeds and support enhanced power management modes of operation. MS 115 devices are typically small and battery-powered (e.g., laptops, cellular phones, and other portable electronic devices).

Although not illustrated in FIG. 1, the WiMAX system 100 can further include one or more relay station (RS). Defined in IEEE 802.16j-2009, RSs are SSs configured to forward traffic to other RSs, SSs, or MSs in a multi-hop Security Zone.

The Operator Network 120 deploys and manages the one or more BSs in the WiMAX system 100. The Operator Network 120 provides the required backhaul for the BS. Various MS and SS are serviced by the WiMAX deployment. A Rogue Station (“rogue”) 125 could be a mobile or fixed device with WiMAX capabilities being operated illegally on the licensed frequencies of the authorized Operator's network. The rogue could behave like a BS or an SS/MS.

It will be appreciated by those of ordinary skill in the art that although two base stations, two subscriber stations, and one mobile subscriber are shown for illustration purposes only within the network of FIG. 1, any number of each communication device can be deployed and operating within the WiMax system 100.

The WiMAX system 100 operates using one or more of various WiMAX topologies. One such topology is Point-to-Point (P2P) topology which is a dedicated long-range, high-capacity wireless link between two sites. Another topology is Point-to-Multipoint (PMP) topology which is composed of a central BS supporting multiple SSs, providing network access from one location to many. Another topology is Multi-hop Relay topology which extends a BS's coverage area by permitting SSs/MSs to relay traffic by acting as relay stations (RSs). Lastly, a Mobile topology can be utilized, which is similar to a cellular network because multiple BSs collaborate to provide seamless communications over a distributed network to both SSs and MSs.

Within conventional WiMax systems today, there are potential security vulnerabilities including lack of mutual authentication, weak encryption algorithms, interjection of reused Traffic Encryption Keys (TEKs), unencrypted management messages, and potential threats and attacks through the use of wireless technology as a communications medium. Although some of these security vulnerabilities are being address through the 802.16 standard, a solution is still needed for many.

Lack of mutual authentication may allow a rogue BS to impersonate a legitimate BS, thereby rendering the SS unable to verify the authenticity of protocol messages received from the BS. This may enable a rogue BS operator to degrade performance by conducting denial of service (DoS) attack, or steal valuable information using forgery attacks against client SSs. This vulnerability can be mitigated by the use of mutual authentication.

The currently used encryption algorithms for encrypting communications, have well-documented weaknesses.

Traffic Encryption Keys (TEKs) are randomly generated by the BS and are used to encrypt WiMAX data messages. Two TEKs are issued to prevent communications disruption during TEK rekeying; the first TEK is used for active communications, while the second TEK remains dormant. TEKs employ a 2-bit encryption sequence identifier to determine which TEK is actively used to secure communications. A 2-bit identifier permits only four possible identifier values, rendering the system vulnerable to replay attacks. The interjection of reused TEKs may lead to the disclosure of data and the TEK to unauthorized parties.

Management messages are not encrypted and are susceptible to eavesdropping attacks. Encryption is not applied to these messages to increase the efficiency of network operations. An adversary may manipulate management messages to disrupt network communications, for example, by denial-of-service (DoS) attacks aimed at the WiMAX system, at specific network nodes, or both.

Using RF to communicate inherently enables execution of a DoS attack by introducing a powerful RF source intended to overwhelm system radio spectrum with noise or interference. This vulnerability is associated with all wireless technologies. The only defense is to locate and remove the source of RF interference. This can be challenging because of the large coverage areas of WMANs.

WiMAX network threats focus on compromising the radio links between WiMAX nodes. Line of sight (LOS) WiMAX systems pose a greater challenge to attack compared with non-line of sight (NLOS) systems because an adversary would have to physically locate equipment between the transmitting nodes to compromise the confidentiality or integrity of the wireless link. NLOS systems provide wireless coverage over large geographic regions, thereby expanding the potential staging areas for both clients and adversaries.

Threats and attack possible in WiMAX systems include radio frequency (RF) jamming attacks, rogue base stations, scrambling attacks, exploitation of unencrypted management messages, Man-in-the-middle (MITM) attacks, and eavesdropping.

RF jamming attacks comprise an adversary introducing a powerful RF signal to overwhelm the spectrum being used by the system, thus denying service to all wireless nodes within range of the interference.

Lack of mutual authentication in WiMAX systems may allow a rogue BS to impersonate a legitimate BS, thereby rendering the SS or MS unable to verify the authenticity of protocol messages received from the BS. Further, if a rogue station intercepted a mobile subscriber's request during network entry procedures, the rogue BS could perform parameter negotiation with the MS causing the MS to possibly operate as an unsecured device. By doing so all the activities of the MS can be monitored in the clear.

Scrambling attacks are the precise injections of RF interference during the transmission of specific management messages. These attacks prevent proper network ranging and bandwidth allocations with the intent to degrade overall system performance. Control packets within downlink and uplink frames may be sniffed, scrambled, and then returned to the network. This causes performance degradation for the victim, and may possibly allow for processing of data from the malicious user if the uplink was targeted.

Exploitation of unencrypted management messages can result in subtle DoS, replay, or misappropriation attacks that are difficult to detect. These attacks spoof management messages to make them appear as though they come from a legitimate BS or SS/MS allowing them to deny service to various nodes in the WiMAX system.

Man-in-the-middle (MITM) attacks occur when an adversary deceives an SS/MS to appear as a legitimate BS while simultaneously deceiving a BS to appear as a legitimate SS/MS. This may allow an adversary to act as a pass-through for all communications and to inject malicious traffic into the communications stream. An adversary can perform an MITM attack by exploiting unprotected management messages during the initial network entry process. If an adversary is able to impersonate a legitimate party to both the SS/MS and BS, an adversary could send malicious management messages and negotiate weaker security protection between the SS/MS and BS. This weaker security protection may allow an adversary to eavesdrop and corrupt data communications.

Eavesdropping occurs when an adversary uses a WiMAX traffic analyzer within the range of a BS and/or SS/MS. The adversary may monitor management message traffic to identify encryption ciphers, determine the footprint of the network, or conduct traffic analysis regarding specific WiMAX nodes.

To overcome the security vulnerabilities such as those described previously herein, a distributed WiMAX security and monitoring system is provided herein. The system is based on a distributed collaborative monitoring architecture, intelligently scanning different frequencies over time and space to detect threats and attacks.

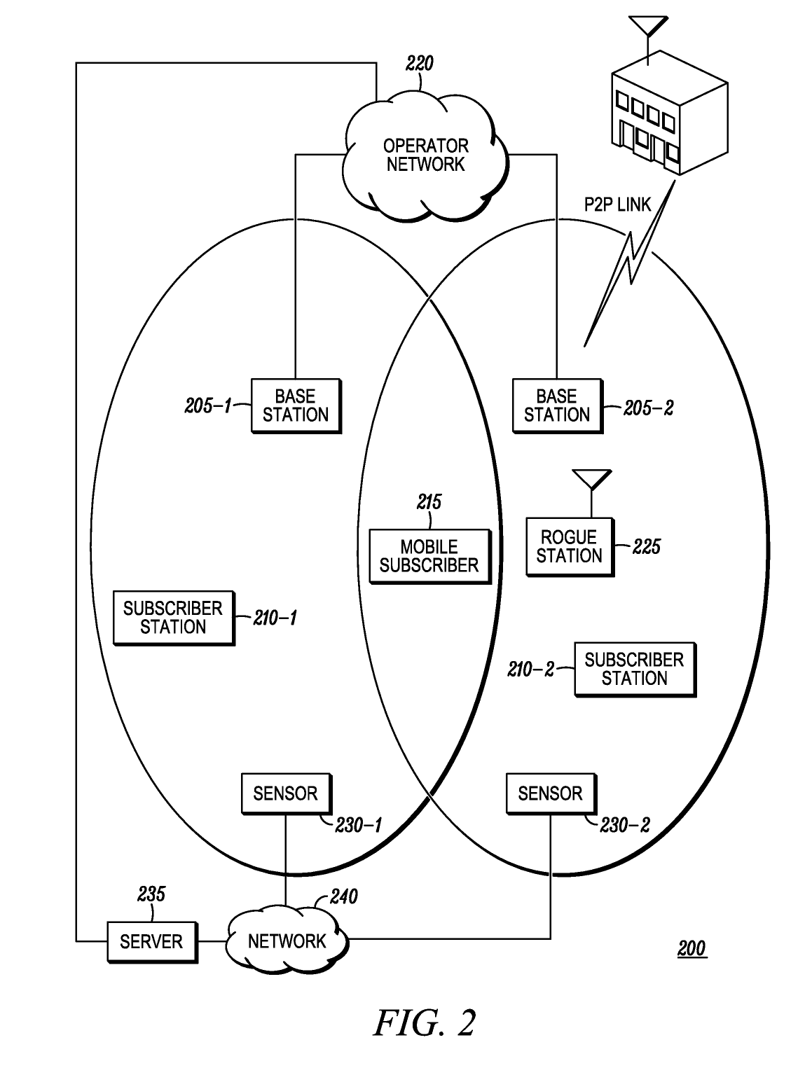

FIG. 2 illustrates a deployment for a security and monitoring system within a WiMAX system 200 in accordance with some embodiments. As described previously herein for FIG. 1, the WiMax system 200 comprises an operator network 220 managing and deploying various communication devices. For example, the WiMAX system 200 comprises one or more base stations (BS) 205-n (such as 205-1 and 205-2 as illustrated). The WiMAX system 200 further comprises subscriber stations (SS) 210-n such as subscriber station 210-1 and 210-2 as illustrated. The WiMAX system 200 further comprises mobile subscribers (MS) 215. Although not illustrated in FIG. 2, the WiMAX system 200 can further include one or more relay station (RS).

In accordance with some embodiments, the WiMAX system 200 further includes WiMAX stations with special firmware allowing promiscuous mode radio frequency (RF) capture which are operating as dedicated sensors 230-n. Promiscuous mode allows sensors 230 to listen to all packets picked up by an antenna incorporated within. In addition, the sensors 230 use an intelligent channel scanning algorithm to detect traffic across the operational WiMAX spectrum. The sensors 230 locally analyze all the received packets, collect several statistics and events of interest and communicate selected events and statistics over a secure link to a centralized server 235 within the WiMAX system 200. The sensors 230 and server 235 are connected using a wired or wireless network 240. The deployed WiMAX network can alternatively provide the operations of the network 240.

The centralized server 235 correlates events and statistics from all the sensors 230 and analyzes the information in several ways to detect rogues, attacks, policy violations, behavioral anomalies, protocol violations, performance issues, and the like. Security policies are centrally managed and monitored from the server 235. The system architecture is such that functionality can be adaptively shifted between the server 235 and sensors 230. The server 235 can ask a sensor 230 to process more events and statistics and provide a consolidated report periodically. It can also ask a sensor 230 to provide a real-time feed of all packets it is detecting at any given time. The server 235 also provides a centralized repository to store observed events and statistics.

It will be appreciated by those of ordinary skill in the art that although two base stations, two subscriber stations, one mobile subscriber and two sensors 230 are shown for illustration purposes only within the network of FIG. 2, any number of each communication device can be deployed and operating within the WiMax system 200.

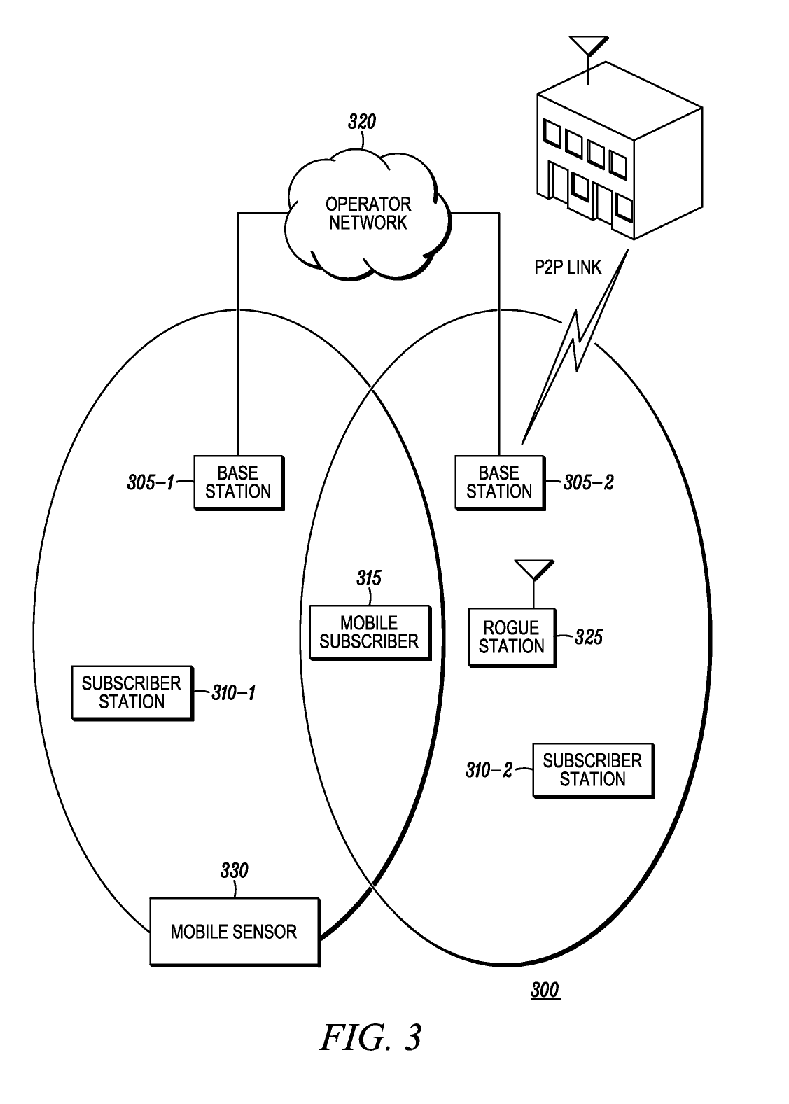

FIG. 3 illustrates a deployment for a security and monitoring system within a WiMAX system 300 in accordance with some embodiments. As described previously herein for FIG. 1, the WiMax system 300 comprises an operator network 320 managing and deploying various communication devices. For example, the WiMAX system 300 comprises one or more base stations (BS) 305-n (such as 305-1 and 305-2 as illustrated). The WiMAX system 200 further comprises subscriber stations (SS) 310-n such as subscriber station 310-1 and 310-2 as illustrated. The WiMAX system 300 further comprises mobile subscribers (MS) 315. Although not illustrated in FIG. 3, the WiMAX system 300 can further include one or more relay station (RS).

FIG. 3 illustrates an embodiment of a WiMAX system 300 with a security and monitoring system implemented without a server. The sensors 330 operate in accordance with some embodiments as standalone units. An example embodiment of such a sensor 330 could be a mobile laptop with a WiMAX radio and custom monitoring software. Monitored WiMAX data is stored, analyzed and processed locally by the sensors 330. A completely sensor-only distributed system can be installed without the need for a server, with configuration and alarms being handled by a third-party, such as a Simple Network Management Protocol (SNMP) based manager.

It will be appreciated by those of ordinary skill in the art that although two base stations, two subscriber stations, one mobile subscriber and one sensor are shown for illustration purposes only within the network of FIG. 3, any number of each communication device can be deployed and operating within the WiMax system 300.

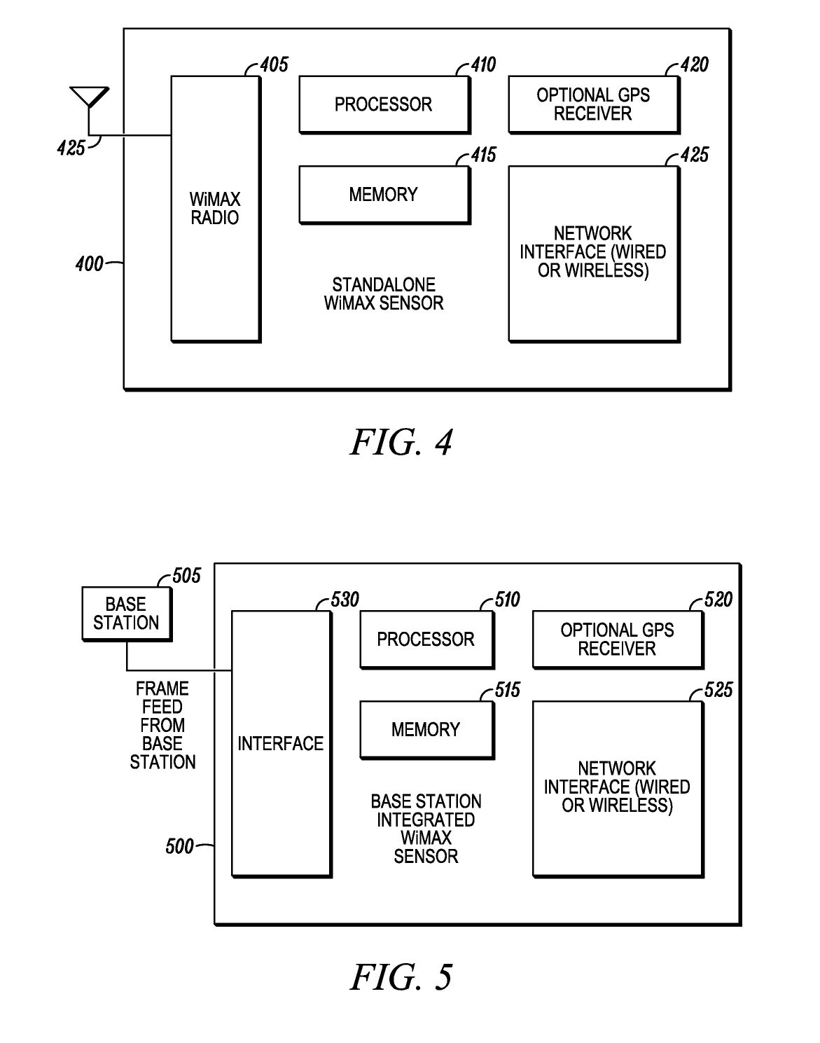

FIG. 4 illustrates an embodiment of a sensor 400. The sensor 400, for example, can be one of the sensors 230 of FIG. 2 or mobile sensors 330 of FIG. 3. The sensor 400 includes a WiMAX radio 405, a processor 410, memory (volatile and non-volatile) 415, a network interface 425 to communicate with a server and/or other devices, and an optional Global Positioning System (GPS) receiver 420 allowing it determine its physical location. The WiMAX radio 405 typically supports promiscuous mode feeds allowing the sensor to capture all WiMAX packets observable by an antenna 425. Fixed sensors may optionally be programmed with their location data. The sensor's network interface could be wired (e.g. Ethernet, Cable, Digital Subscriber Line (DSL), and the like) or wireless (WiMAX, Cellular, and the like), allowing it to communicate with the server or other devices.

FIG. 5 illustrates an embodiment of a “BS-integrated” sensor 500. The sensor 500, for example, can be one of the sensors 230 of FIG. 2 or mobile sensors 330 of FIG. 3. Such a sensor may get its WiMAX packet feeds from the operator's BS 505 directly through an interface 530. The sensor 500 includes a processor 510, a memory (volatile and non-volatile) 515, a network interface 525 to communicate with a server and/or other devices, and an optional Global Positioning System (GPS) receiver 520 allowing it determine its physical location. Fixed sensors may optionally be programmed with their location data. The sensor's network interface could be wired (e.g. Ethernet, Cable, DSL, etc.) or wireless (WiMAX, Cellular, etc.), allowing it to communicate with the server or other devices.

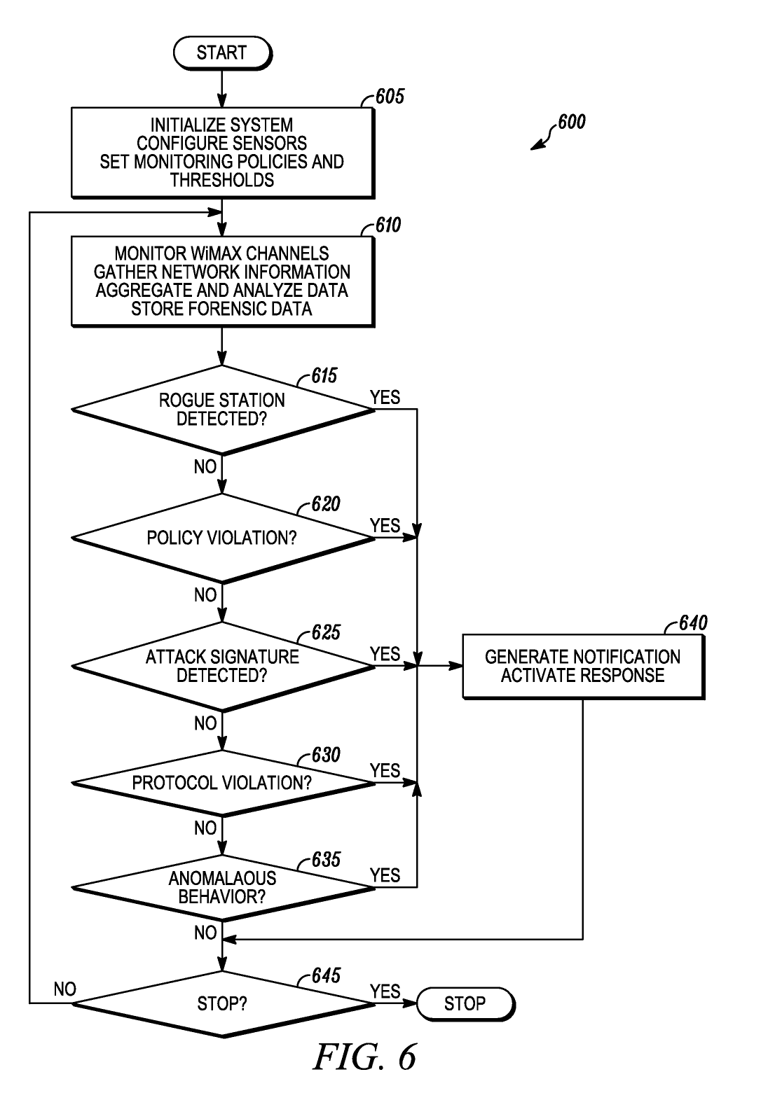

FIG. 6 is a flowchart illustrating an operation 600 of a WiMAX system incorporating a security and monitoring system in accordance with some embodiments. As illustrated, the operation begins with initializing the system including configuring the server and sensors and monitoring policies and thresholds are set in 605. The characteristics of the deployed WiMAX network such as a list of authorized BSs and their location, operating channels, supported authentication and encryption schemes, and the like are specified in the system. Alternatively, the server may automatically import this data from the operator's network using a pre-determined mechanism. Various thresholds for WiMAX protocol related parameters such as ranging, power levels, re-transmission limits, sleep mode characteristics, and the like can also be programmed in the system. Once initialized, the sensors in 610 start monitoring communications activity, such as WiMAX activity, on one or more channels. Channel scan patterns can be specified or automatically optimized based on activity observed. The sensors analyze collected information and report a summary of events and statistics to the server.

Next, the server aggregates data from various sensors, maintains a centralized forensic record of events and statistics, and, in 615 through 635 runs various tests to detect rogues, policy violations, known attacks, protocol violations and anomalous behavior. For example, the server determines whether a rogue station is detected in 615, whether there is a policy violation in 620, whether an attack signature is detected in 625, whether there is a protocol violation in 630, and whether there is an anomalous behavior in 635. For each of these operations, if one or more of the issues is detected, the operation continues to Step 640 in which notifications are triggered in response to observed issues. Notifications could be in the form of alarms on a computer console, messages such as email or short messaging service (SMS) or page, events sent to incident management systems, and the like. The system can also automatically respond if certain conditions are detected. For example, if a rogue is detected, the system may automatically trigger a location tracking operation to determine the physical coordinates of the station and dispatch appropriate personnel. Similarly, if a station is not following a predetermined security policy, it may instruct the operator network to deny access to the station. If excessive performance degradation is observed, the system could trigger an analysis wizard to determine the root cause (such as interference, denial-of-service (DoS), misconfiguration, and the like). The monitoring process is continued until stopped in 645.

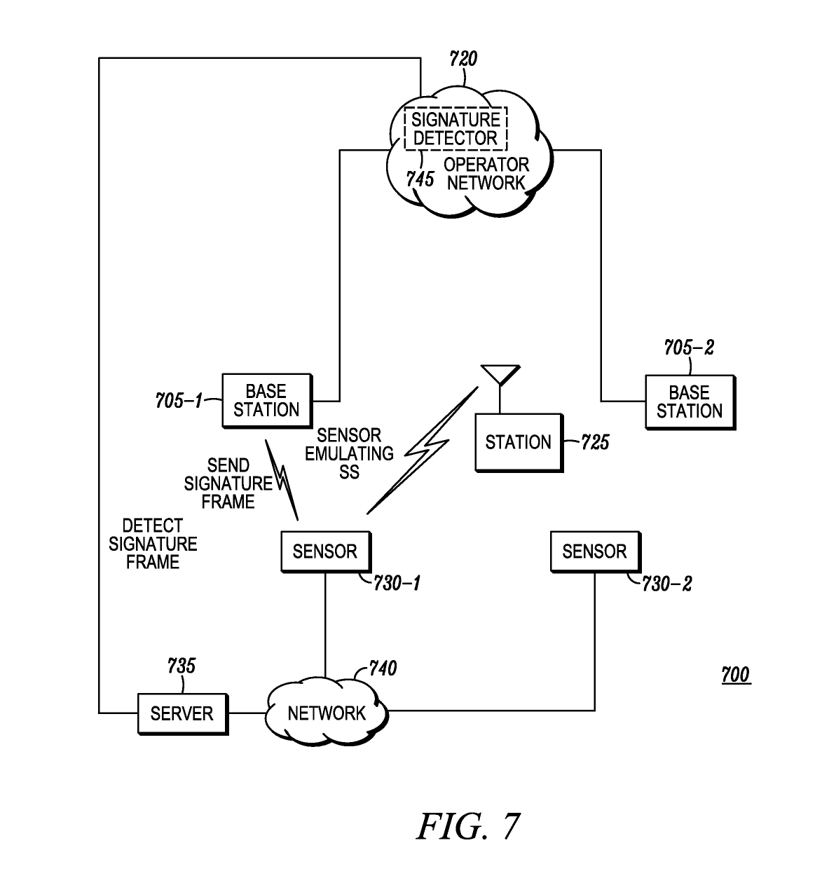

FIG. 7 illustrates a WiMAX system 700 operating in accordance with one embodiment to determine if an observed BS is a rogue BS. As illustrated, the WiMAX system 700 includes an operator network 720, one or more base stations (BS) 705-n (such as 705-1 and 705-2 as illustrated), one or more sensors 730 (such as sensors 730-1 and 730-2), and a centralized server 735 communicatively coupled to the sensors 730 through a network 740.

In operation, a sensor 730 (such as 730-1 as illustrated) emulates a subscriber station (SS) including communicating with an unknown station such as station 725. The sensor 730 then connects to a base station 705 (such as 705-1 as illustrated). The sensor 730-1 sends a signature packet to the unknown station 725. The operator network 720, for example using a signature detector 745, determines if the signature packet is received and is legitimate. In one embodiment, communicating the signature packet from the at least one sensor to the signature detector includes communicating a known signature packet from the sensor to the signature detector through a base station, such as base station 705-1. When the signature packet is not received, then the unknown station (i.e. station 725) is flagged as a rogue station.

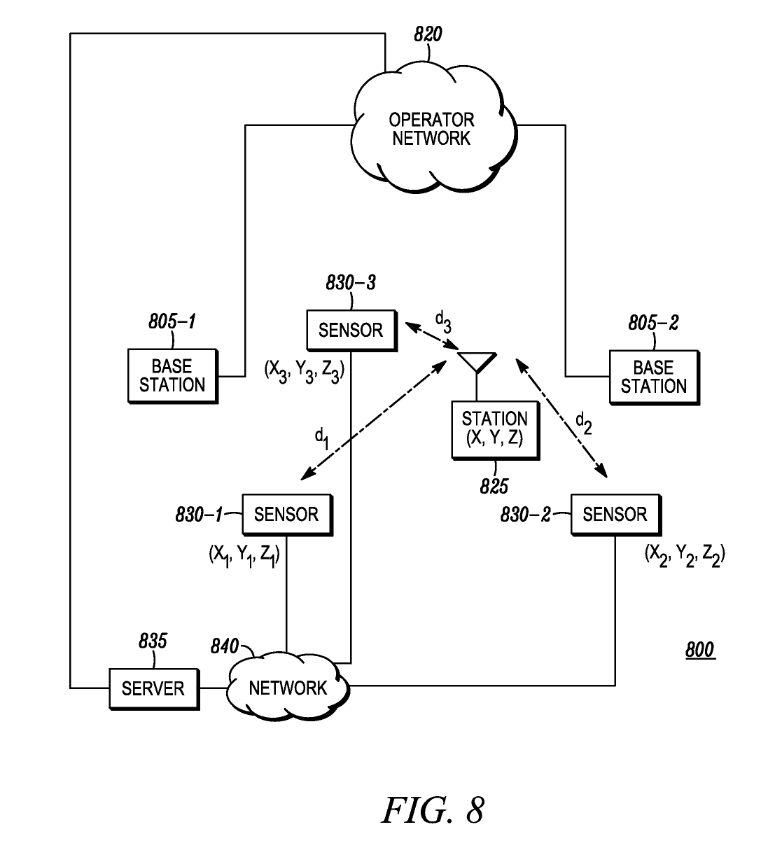

FIG. 8 illustrates a WiMAX system 800 operating in accordance with one embodiment using triangulation based location tracking to determine whether a station is a rogue station. As illustrated, the WiMAX system 800 includes an operator network 820, one or more base stations (BS) 805-n (such as 805-1 and 805-2 as illustrated), at least three sensors 830 (such as sensors 830-1, 830-2, and 830-3), and a centralized server 835 communicatively coupled to the sensors 830 through a network 840.

In operation, the sensors 830 can estimate the relative distance of a device on interest (such as unknown station 825) based on the received signal strength and estimated propagation path loss. Using the known co-ordinate location of three or more sensors (8301-1, 830-2, and 830-3), the co-ordinates of the unknown station 825 can be calculated. In one embodiment, the location of a unknown station 825 may be computed using this techniques and the computed location may then be compared with the list of known BSs and their locations, for example within the server 835. If they do not match then the unknown station 825 could be flagged as a rogue station.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for security and monitoring within a worldwide interoperability for microwave access (WiMAX) network comprising:
monitoring, by one or more sensors, communications activity on one or more channels;
providing a report of the monitored communications activity from each of the one or more sensors to a server;
analyzing, by the server, the reports of the monitored communication activity for detection of one or more system incidents; and
triggering, by the server, in response to detection of one or more incidents, an incident notification.

2. The method as claimed in claim 1, wherein the one or more system incidents comprise one or more of a rogue station, a policy violation, a known attack, a protocol violation, and an anomalous behavior.

3. The method as claimed in claim 1, further comprising, when the one or more system incidents comprise a station not following a predetermined security policy:
instructing an operator network, by the server, to deny access to the station.

4. The method as claimed in claim 1, further comprising, when the one or more system incidents comprise an excessive performance degradation:
triggering, by the server, an analysis wizard to determine a root cause of the performance degradation.

5. The method as claimed in claim 1, further comprising, when the one or more system incidents comprises detection of a rogue station:
triggering a location tracking operation to determine a location of the rogue station.

6. The method as claimed in claim 1, further comprising, when the one or more system incidents comprises detection of an unknown station:
estimating, by one or more sensors, a relative distance of the unknown station;
calculating, by the server, a location of the unknown station using sensor locations of each of the one or more sensors;
comparing, by the server, the calculated location of the unknown station to a list of known stations and associated locations; and
when the calculated location does not match an associated location of a known station, identifying, by the server, the unknown station as a rogue station.

7. The method as claimed in claim 6, wherein the relative distance is estimated based at least in part on a received signal strength and an estimated propagation path loss.

8. The method as claimed in claim 1, further comprising prior to the monitoring by the one or more sensors:
configuring at least one server and the one or more sensors including setting one or more monitoring policies and thresholds.

9. The method as claimed in claim 8, wherein the configuring includes identifying a list of authorized base stations and their location, one or more operating channels, and one or more supported authentication and encryption schemes.

10. The method as claimed in claim 8, wherein the configuring includes automatically importing, by the server, one or more of a list of authorized base stations and their location, one or more operating channels, and one or more supported authentication and encryption schemes.

11. The method as claimed in claim 1, wherein the monitoring by the one or more sensors comprises promiscuous mode radio frequency capture.

12. The method as claimed in claim 1, wherein the monitoring by the one or more sensors comprises using an intelligent channel scanning algorithm to detect traffic on the one or more channels.

13. The method as claimed in claim 1, further comprising prior to the providing of the report operations:
requesting, by the server, to the one or more sensors, to process more events and statistics and provide a consolidated report periodically.

14. The method as claimed in claim 1, further comprising prior to the providing of the report operations:
requesting, by the server, to the one or more sensors, to provide a real-time feed of all packets it is detecting at any given time.

15. The method as claimed in claim 1, further comprising:
storing, by the server, all observed events and statistics within the received reports of the monitored communication activity.

16. A method for security and monitoring within a worldwide interoperability for microwave access (WiMAX) network comprising:
monitoring, by one or more sensors, communications activity on one or more channels;
analyzing, by each of the one or more sensors, the monitored communication activity for detection of one or more system incidents; and
triggering, by one of the one or more sensors, in response to detection of one or more incidents, an incident notification.

17. The method as claimed in claim 16, further comprising, when the one or more system incidents comprises detection of an unknown station:
estimating, by the one or more sensors, a relative distance of the unknown station;
calculating, by the one or more sensors, a location of the unknown station using sensor locations of each of the one or more sensors;
comparing, by the one or more sensors, the calculated location of the unknown station to a list of known stations and associated locations; and
when the calculated location does not match an associated location of a known station, identifying, by the one or more sensors, the unknown station as a rogue station.

18. The method as claimed in claim 17, wherein the relative distance is estimated based at least in part on a received signal strength and an estimated propagation path loss.

19. A method for security and monitoring within a worldwide interoperability for microwave access (WiMAX) network comprising:
communicating, by at least one sensor, with an unknown station;
communicating a signature packet to the unknown station from the at least one sensor;
determine, by the signature detector within the WiMAX network, if the signature packet is received and is legitimate; and
when the signature packet is not received, flagging the unknown station as a rogue station.

20. The method as claimed in claim 19, wherein the signature detector operates within an operator's network of the WiMAX network, and wherein communicating the signature packet from the at least one sensor to the signature detector comprises:
communicating a known signature packet from the sensor to the signature detector through a base station.

21. The method as claimed in claim 19, further comprising prior to communicating by the at least one sensor with an unknown station:
emulating, by the at least one sensor, a subscriber station.
